(19) United States
(12) Patent Application Publication
(10) Pub. No.: US 2014/0117762 A1
(43) Pub. Date: May 1, 2014

(54) Battery System

(71) Applicants: Shin Yamauchi, Mito (JP); Hiromu Kakuya, Hitachinaka (JP); Motoo Futami, Hitachiota (JP); Toshiki Takahashi, Higashimurayama (JP); Tsutomu Sudo, Atsugi (JP)

(72) Inventors: Shin Yamauchi, Mito (JP); Hiromu Kakuya, Hitachinaka (JP); Motoo Futami, Hitachiota (JP); Toshiki Takahashi, Higashimurayama (JP); Tsutomu Sudo, Atsugi (JP)

(73) Assignee: Hitachi, Ltd., Chiyoda-ku, Tokyo (JP)

(21) Appl. No.: 13/391,998

(22) PCT Filed: Jun. 20, 2011
(86) PCT No.: PCT/JP11/64041

§ 371 Date: Feb. 23, 2012

(51) Int. Cl. H02J 7/00

(52) U.S. Cl. CPC H02J 7/0014
USPC 307/48

(57) ABSTRACT

An objective of the invention is to deal with difference of the internal resistance of batteries.

A battery system (1) including a plurality of battery modules (3) connected, wherein the higher the temperature of the location where the battery module (3) is located becomes, the larger the resistance value of a distribution cable (11) is made. In a chassis (2), the distribution cable (11) located where the temperature is high is made longer and the distribution cable (11) located where the temperature is low is made shorter. More specifically, the distribution cable (11) connected to a battery group (4) located on the upper part of the chassis is made longer and the distribution cable (11) connected to a battery group (4) located on the lower part of the chassis is made shorter. Further, the length of the distribution cable (11) may be adjusted by arranging the output terminal (21) on the lowermost part of the chassis (2).

### CROSS REFERENCE TO RELATED APPLICATIONS

This application is a National Stage Application of PCT/JP2011/064041, filed on Jun. 20, 2011, and which application is incorporated herein by reference. To the extent appropriate, a claim of priority is made to the above disclosed application.

### FIELD OF THE INVENTION

The present invention relates to a battery system which includes a plurality of batteries.

### BACKGROUND ART

In a battery system which includes a plurality of batteries, it is important to equalize, between each set of batteries, resistance caused by the batteries and distribution cables connected to the batteries.

In patent documents 1 to 3, there are described wiring techniques in which, in a battery system including a plurality of batteries, the resistance values of the distribution cables connected to the batteries are equalized by equalizing the length, cross-section area and resistivity of the distribution cables from each of the batteries, and consequently the resistance of each of the batteries are equalized.

### PATENT DOCUMENT

Patent Document 1: Japanese Patent Application Laid-open JP2010-80135A
Patent Document 2: Japanese Patent Application Laid-open JP H06-165310A
Patent Document 3: Japanese Patent Application Laid-open JP2006-42407A

### SUMMARY OF THE INVENTION

### Problems to be Solved by the Invention

The techniques described in patent documents 1 to 3 are effective in a case where the internal resistance is small enough compared with that of the distribution cables, for example in a case of a lead battery. However, with respect to a lithium battery or the like where the internal resistance is larger than that of a lead battery, the internal resistance component of the battery is not negligible, and further the internal resistance varies due to the heat generation during discharge and charge. Thus, even when the resistance of the distribution cable is equalized, the resistance of each of the batteries becomes uneven due to the change of the internal resistance of the batteries. As a result, the electrical load is concentrated on the battery whose internal resistance is small. This can be a cause of disturbing effective use of the electrical power of the battery system, or accelerating deterioration of the batteries due to concentration of the load.

In light of the above, the present invention has been made, and the purpose of the invention is to deal with the difference between the internal resistances of the batteries.

### Means for Solving the Problem

For solving the problem above, the present invention is a battery system including a plurality of batteries connected, wherein a resistance of a distribution cable connected to a battery located on a location where a temperature becomes high is made larger than that of a distribution cable connected to a battery located on a location where a temperature does not become high.

### Advantageous Effect of the Invention

According to the present invention, it is possible to deal with a difference of the internal resistance of batteries.

### BRIEF DESCRIPTION OF THE DRAWINGS

FIG. 1 is an external perspective view of a battery system according to the first embodiment of the invention;

FIG. 2 is a graph which represents the relation between location and temperature of a battery group in a chassis;

FIG. 3 is a graph which represents the relation between the internal resistance and temperature of a cell battery;

FIG. 4 is a diagram showing a wiring example of the battery system according to the first embodiment;

FIG. 5 is a diagram showing another wiring example of the battery system according to the first embodiment;

FIG. 6A is a diagram showing an arrangement of battery modules of the battery system according to the second embodiment;

FIG. 6B is a graph which represents the relation between location and temperature of the battery group in the chassis according to the second embodiment; and

FIG. 7 is a diagram showing a wiring example of the battery system according to the second embodiment.

### DETAILED DESCRIPTION OF THE INVENTION

Hereinafter, a mode for implementing the present invention (called an “embodiment”) will be explained in detail with reference to the drawings. In the drawings, similar symbols are used to denote similar components, and redundant explanations are omitted.

Here, in this embodiment, the battery system is considered as normal when it is in operation in thermally-stable condition.

### First Embodiment

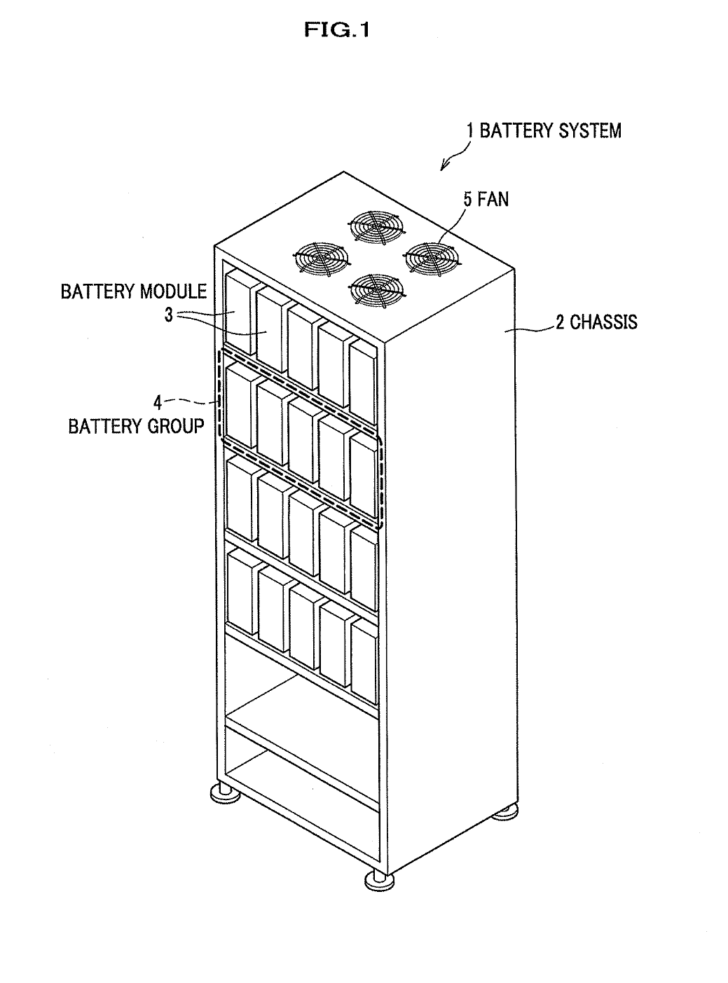

FIG. 1 is an external perspective view of a battery system according to the first embodiment of the invention.

In a battery system 1 according to the embodiment, battery modules 3 including a plurality of cell batteries (not shown) are horizontally stored per each column in the chassis 2. Here, a group of battery modules 3 in each column is called as a battery group 4.

On the upper surface of the chassis 2, there is provided a fan 5 for releasing heat generated in the chassis 2. The fan 5 may be omitted as needed.

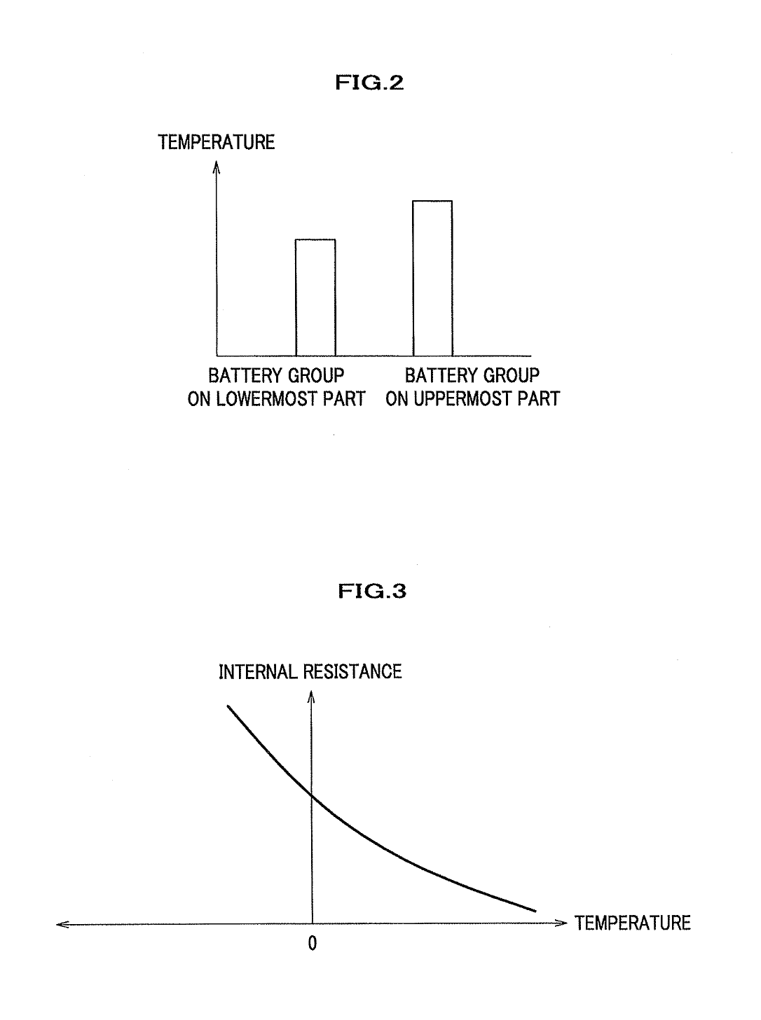

FIG. 2 is a graph which represents the relation between location and temperature of a battery group in a chassis.

The inventor found that, as shown in FIG. 2, the temperature of the battery group 4 on the uppermost part of the chassis 2 of FIG. 1 tends to be higher than that of the battery group 4 on the lowermost part. It is considered to be caused by the upcoming heat generated by the battery module 3.

FIG. 3 is a graph which represents the relation between the internal resistance and temperature of a cell battery.

As shown in FIG. 3, it is known with respect to a cell battery like a lithium-ion battery that, when the temperature of the cell battery is increased, the viscosity of the solution in the cell battery decreases. Consequently, the mobility of ion increases and the internal resistance decreases.

As explained in FIG. 2, since the temperature of the battery group 4 on the uppermost part of the chassis 2 is high, the internal resistance of the battery group 4 on the uppermost part of the chassis 2 is small. Further, since the temperature of the battery group 4 on the lowermost part of the chassis 2 is lower than that of the battery group 4 on the uppermost part, the internal resistance is larger than that of the cell battery on the uppermost part of the chassis 2.

Therefore in this embodiment, the resistance of the battery groups 4 on both the uppermost and lowermost parts of the chassis 2 are equalized by increasing the resistance of the distribution cables 11 connected to the battery groups 4 on the uppermost part of the chassis 2, and decreasing the resistance of the distribution cables 11 connected to the battery groups 4 on the lowermost part of the chassis 2.

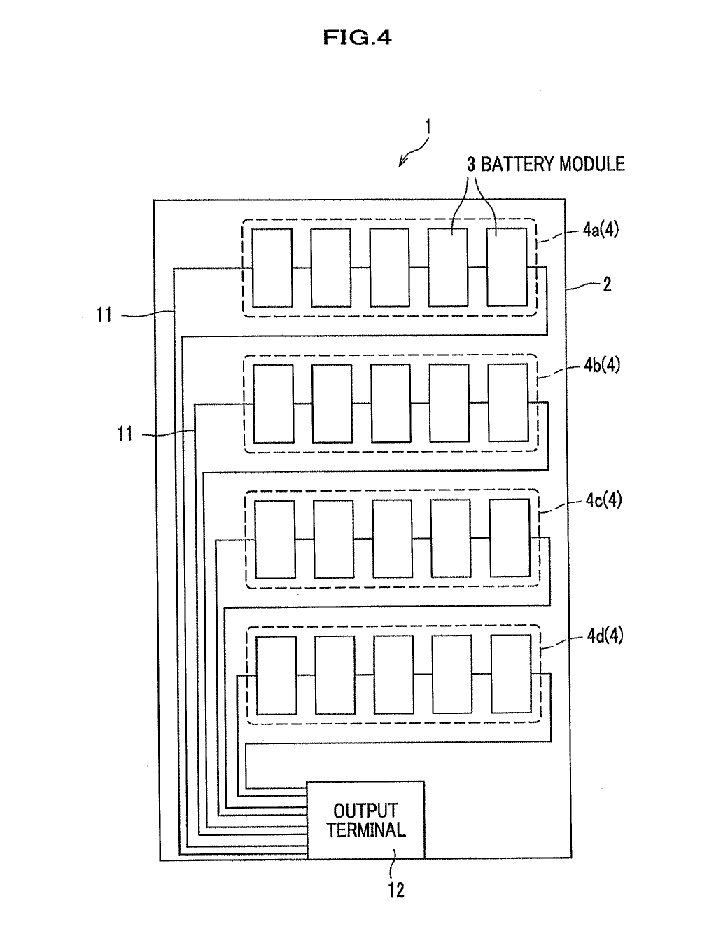

FIG. 4 is a diagram showing a wiring example of the battery system according to the first embodiment.

In the example of FIG. 4, each battery group 4 is provided with five battery modules 3 connected in series. Further, four battery groups 4 in total are connected in parallel with an output terminal 12 and stored in the chassis 2.

As shown in FIG. 4, the output terminal 12 which outputs power of the battery groups 4 is arranged on the lowermost part of the chassis 2. Thus, the battery groups 4 where the temperature is high, i.e. the higher position of the chassis 2 where the internal resistance of the cell battery is small, are connected by the distribution cable 11 having the longer length. In other words, with respect to the battery group 4a, battery group 4b, battery group 4c, and battery group 4d arranged in sequence from the uppermost part of the chassis 2 as shown in FIG. 4, the length of the distribution cable 11 of the batteries 4 are determined so that the following relation is satisfied: battery group 4a>battery group 4b>battery group 4c>battery group 4d. Thus, the resistance of the battery groups 4 is equalized by making the resistance larger of the distribution cable 11 connected to the battery groups 4 as the position of the battery group 4 becomes higher in the chassis 2. In other words, the battery group 4 located on the position having higher temperature is connected by the longer distribution cable 11.

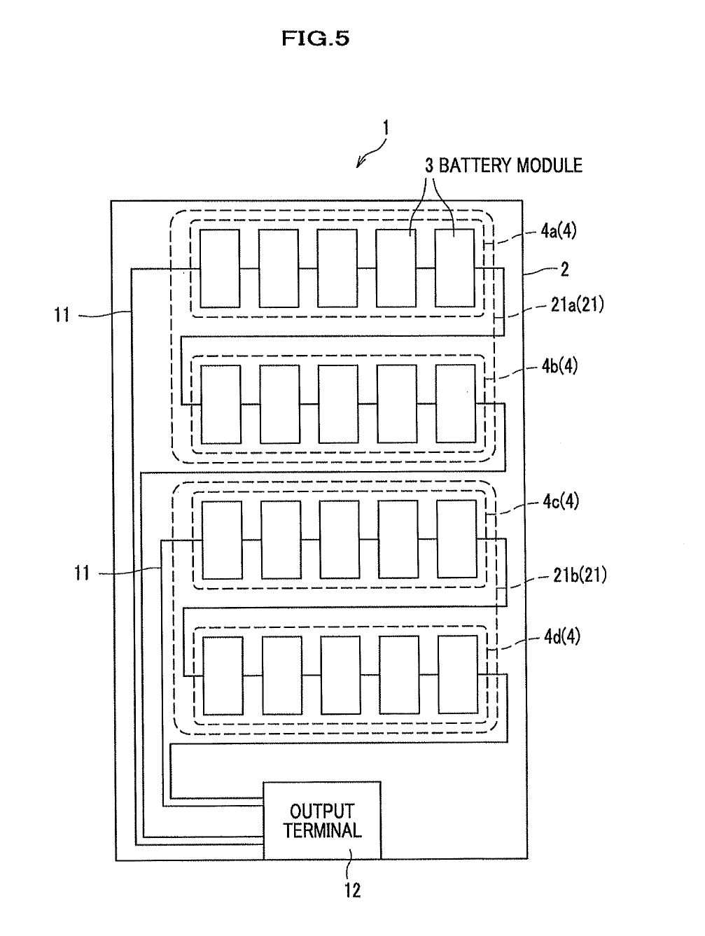

FIG. 5 is a diagram showing another wiring example of the battery system according to the first embodiment.

In FIG. 5, similarly to FIG. 4, the output terminal 12 is arranged on the lowermost part of the chassis 2. Thus the length of the distribution cable 11 connected to the battery group 4 is made longer as the location of the battery group 4 becomes higher in the chassis 2 where the internal resistance of the cell battery is small.

However, in contrast to the battery groups 4 in FIG. 4 which are connected in parallel, the battery groups 4 in FIG. 5 are divided into two groups 21, and two battery groups 4 are connected in series in each of the groups 21. In addition, two groups 21 are connected to the output terminal 12 in parallel. Here, two battery groups 4 on the upper position and two battery groups 4 on the lower position constitute the two groups 21. The length of each distribution cables 11 connected to each group are different from each other.

Thus, the resistance of each of the groups 21 may be equalized by dividing the battery groups 4 into a plurality of upper and lower groups 21, and making the length of the distribution cable 11 longer for the group 21 that is located on the higher position and making the resistance larger accordingly.

In other words, assuming that the battery group 4a, battery group 4b, battery group 4c, and battery group 4d are defined in the same way as FIG. 4, making the battery group 4a and battery group 4b as a group 21a, making the battery group 4c and battery group 4d as a group 21b, then the relation of the length of the distribution cable 11 to each of the groups 21 can be represented as group 21a>group 21b.

### Second Embodiment

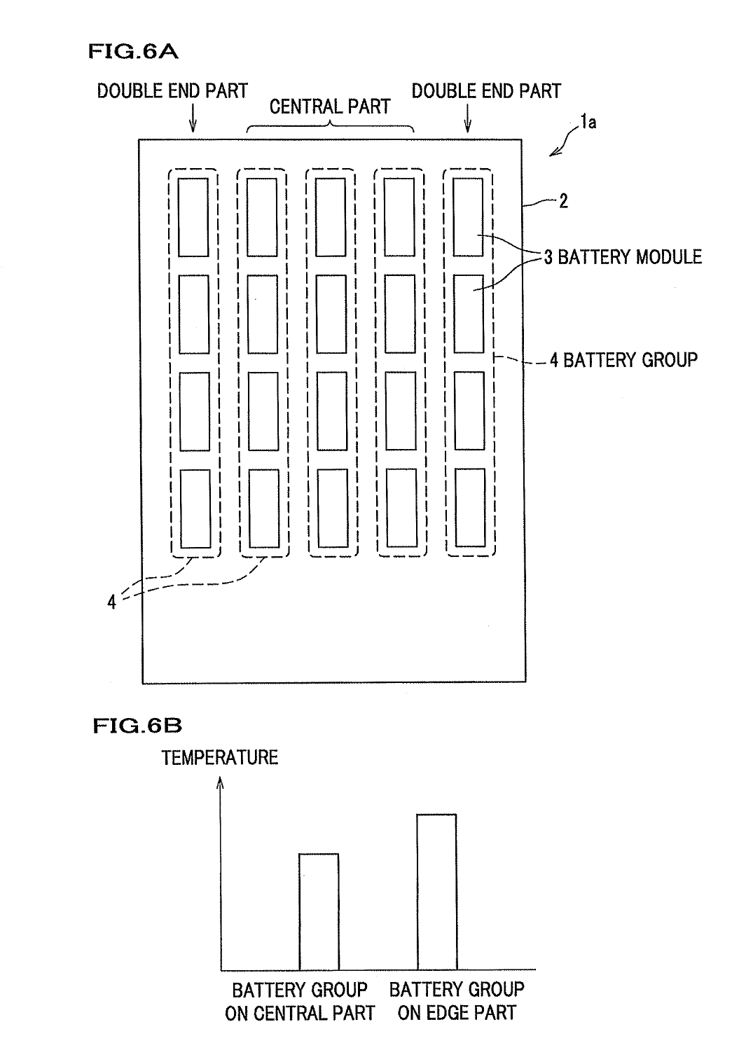

Hereinafter, a case where the battery modules 3 are stored vertically as shown in FIG. 6A will be explained.

In a battery system 1a shown in FIG. 6A, the battery modules 3 are stored vertically. In the example of FIG. 6A, four battery modules 3 are vertically connected in series (the connection is not shown in FIG. 6A), and constitute a battery group 4. Then, five battery groups 4 are arranged horizontally.

Here, right and left end parts of the chassis 2 storing the battery group 4 are called as a double end part, and a part positioned in the middle of the chassis 2 in a horizontal direction is called as a central part.

Meanwhile, a fan 5 may be disposed on the upper surface of the chassis 2.

FIG. 6B is a graph which represents the relation between location and temperature of the battery group 4 in a case where the fan 5 is disposed on the upper surface of the chassis 2.

In a case where the fan 5 is disposed on the upper surface of the chassis 2 (not shown in FIG. 6), the central part of the chassis 2 can receive large airflow, but the double end part may not receive large airflow. For this reason, as shown in FIG. 6, the temperature of the battery group 4 on the double end part may rise higher than that of the battery group 4 on the central part of the chassis 2.

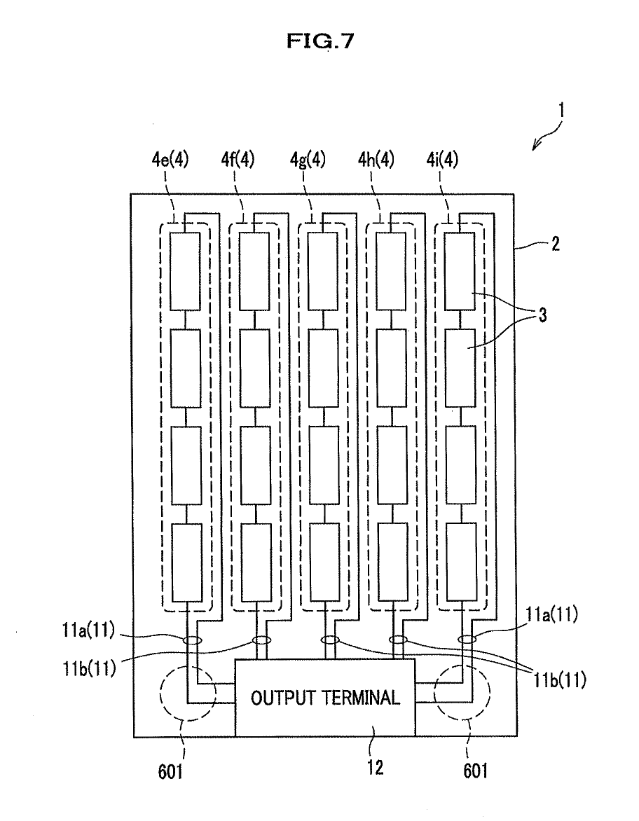

FIG. 7 is a diagram showing a wiring example of the battery system of FIG. 6.

In the example of FIG. 7, five battery groups 4 (4e to 4i) are vertically connected in parallel with the output terminal 12.

From the left of the figure, symbols are given as, a battery group 4e, a battery group 4f, a battery group 4g, a battery group 4h, and a battery group 4i, a distribution cable 11a connected to the battery group 4e and the battery group 4i, a distribution cable 11b connected to the battery group 4f, the battery group 4g, and the battery group 4h.

Here, the length of the distribution cables 11 is determined so that the following relation is satisfied: distribution cable 11a>distribution cable 11b. More specifically, the distribution cable 11a is made longer than the distribution cable 11b at a position shown with a symbol 601.

In other words, the battery group 4e and the battery group 4i are located where the temperature is high, and the distribution cables 11a connected to these batteries are made long. The battery group 4f, the battery group 4g and the battery group 4h located are located where the temperature is low, and the distribution cables 11b connected to these batteries are made short.

By doing so, the distribution cables 11a connected to the battery group 4e and the battery group 4i located on the double end part where the temperature tends to be high are made longer. Thus the resistance thereof is made larger than those of the distribution cables 11b connected to the battery group 4f, the battery group 4g and the battery group 4h located on the central part. As a result the resistance of the battery groups 4 is equalized.

Meanwhile, also in the second embodiment, a plurality of the battery groups 4 may be grouped such that each of the groups is connected in parallel with the output terminal 12.

Further, in the embodiments (the first and second embodiments), although the resistance of the distribution cable 11 is increased by making the strength longer, the resistance may also be increased by making the distribution cable 11 thinner, or using material having larger resistance for the distribution cable 11, or inserting a resistor element on the way.

In addition, in the embodiments, although the output terminal 12 is disposed on the lowermost part, it does not necessarily be disposed on the lowermost part as long as the resistance of the distribution cable 11 connected to the battery group 4, which is located on a location where the temperature is high, can be made larger. For example, the output terminal 12 may be disposed on other location than the lowermost position, if the resistance of the distribution cable 11 can be made larger by making the distribution cable 11 thinner, or using material having larger resistance for the distribution cable 11, inserting a resistor or coil or the like on the way.

Further, in the embodiments, five battery modules 3 constitute a battery group 4, and four or five battery groups 4 are stored in the chassis 2 as shown in the example. In addition, in FIG. 5, two battery groups 4 are stored in a group 21 in the example. Of course, these numbers are not limited to these examples.

### SUMMARY

In the present embodiments, the resistances of the battery groups 4 are equalized by making the length longer of the distribution cable 11 connected to the battery groups 4 located where the temperature is high, and shortening the distribution cable 11 connected to the battery groups 4 located where the temperature is low. In other words, the present invention does not equalize the resister values of the distribution cables 11 connected to the batteries like the patent documents 1 to 3. Instead, the resister values of the distribution cable 11 is varied in accordance with the connected battery groups 4 by design.

Thus, including batteries having the large internal resistance such as a lithium battery, it is possible to equalize the resistance of the battery groups 4 and prevent load from being concentrated on one battery.

Herewith, it is possible to effectively use the power in the battery systems 1 and 1a, and to prevent the deterioration of the batteries due to load concentration from occurring.

### DESCRIPTION OF THE SYMBOLS

1, 1a battery system
2 chassis
3 battery module (battery)
4, 4a to 4i battery group
5 fan
11, 11a, 11b distribution cable
12 output terminal
21, 21a, 21b group

1. A battery system including a plurality of batteries connected, wherein a resistance of a distribution cable connected to a battery located on a location where a temperature becomes high is made larger than that of a distribution cable connected to a battery located on a location where a temperature does not become high.

2. The battery system according to claim 1,
wherein the resistance of the distribution cable is made larger by making a length of the distribution cable longer.

3. The battery system according to claim 1,
wherein an output terminal through which power of the batteries is outputted is located on a location where a temperature is low in a chassis in which the batteries are stored.

4. The battery system according to claim 3, wherein the output terminal is located on a lowermost part of the chassis.

5. The battery system according to claim 1, wherein the batteries are connected horizontally in series and the distribution cable is made longer as the position of the battery group becomes higher in a chassis in which the batteries are stored.

6. The battery system according to claim 1, wherein the batteries are connected vertically in series and the distribution cable is made longer as the position of the battery group becomes closer to a side face in a chassis in which the batteries are stored.

7. The battery system according to claim 2,
wherein an output terminal through which power of the batteries is outputted is located on a location where a temperature is low in a chassis in which the batteries are stored.

8. The battery system according to claim 2, wherein the batteries are connected horizontally in series and the distribution cable is made longer as the position of the battery group becomes higher in a chassis in which the batteries are stored.

9. The battery system according to claim 3, wherein the batteries are connected horizontally in series and the distribution cable is made longer as the position of the battery group becomes higher in a chassis in which the batteries are stored.

10. The battery system according to claim 4, wherein the batteries are connected horizontally in series and the distribution cable is made longer as the position of the battery group becomes higher in a chassis in which the batteries are stored.

11. The battery system according to claim 2, wherein the batteries are connected vertically in series and the distribution cable is made longer as the position of the battery group becomes closer to a side face in a chassis in which the batteries are stored.

12. The battery system according to claim 3, wherein the batteries are connected vertically in series and the distribution cable is made longer as the position of the battery group becomes closer to a side face in a chassis in which the batteries are stored.

13. The battery system according to claim 4, wherein the batteries are connected vertically in series and the distribution cable is made longer as the position of the battery group becomes closer to a side face in a chassis in which the batteries are stored.
